(19) United States
(12) Patent Application Publication
(10) Pub. No.: US 2024/0411049 A1
(43) Pub. Date: Dec. 12, 2024

(54) Method for determining productivity of deep coalbed methane well considering impacts of fracturing fluids and produced water

(71) Applicant: Exploration & Production Research Institute of SINOPEC North-China Oil & Gas Company, Zhengzhou city (CN)

(72) Inventors: Bo Hu, Zhengzhou city (CN); Yongyi Zhou, Zhengzhou city (CN); Kui Chen, Zhengzhou city (CN); Linsong Liu, Zhengzhou city (CN); Yongmin He, Chengdu City (CN); Yaonan Yu, Zhengzhou city (CN); Yuanxiang Sun, Zhengzhou city (CN)

(21) Appl. No.: 18/810,509

(22) Filed: Aug. 21, 2024

(51) Int. Cl. G01V 99/00

(52) U.S. Cl. CPC G01V 99/00

(57) ABSTRACT

A method for determining productivity of deep coalbed methane well considering impacts of fracturing fluids and produced water includes steps of: based on coalbed methane PVT experimental data, determining a relationship table between pressure and deviation factor, and determining process parameter; recording daily gas production rates, bottomhole flow pressures, cumulative gas productions, and cumulative water production; determining formation pressures based on a coalbed methane material balance equation considering the impacts of the fracturing fluids and the produced water; according to the formation pressures, the bottomhole flow pressures and the production rates, determining coefficients in a deliverability equation for the coalbed methane well, thereby determining the deliverability equation; putting the formation pressure and the bottomhole flow pressures into the deliverability equation and solving for the productivity of the coalbed methane well. The productivity evaluation results of the method are more in line with actual production data.

### CROSS REFERENCE OF RELATED APPLICATION

The present invention claims priority under 35 U.S.C. 119(a-d) to CN 202410117474.8, filed Jan. 29, 2024.

### BACKGROUND OF THE PRESENT INVENTION

### Field of Invention

The present invention relates to coalbed methane development and research, and more particularly to a method for determining a productivity of a deep coalbed methane well considering impacts of fracturing fluids and produced water.

### Description of Related Arts

Determining the deliverability equation and productivity of coalbed methane wells is a very important daily work in dynamic analysis, which is also an important basis for the prediction of gas well production law, analysis of production potential and optimization of working system. The fracturing scale of deep coalbed methane wells is often very large, wherein the amount of fluid used is often over 3 ten-thousand cubic meters, even up to 5 ten-thousand cubic meters or more. Furthermore, there is also a large amount of produced water during the extraction process, while there is no disclosure of how to take into account the impacts of fracturing fluid and produced water on the productivity of deep coalbed methane in the prior art. Therefore, there is an urgent need to propose a method for determining the productivity of deep coalbed methane wells that takes into account the impacts of the fracturing fluid and the produced water.

### SUMMARY OF THE PRESENT INVENTION

An object of the present invention is to provide a method for determining a productivity of a deep coalbed methane well considering impacts of fracturing fluids and produced water, aiming at solving the technical problem that the impacts of the fracturing fluid and the produced water cannot be considered in conventional method for determining the productivity of the deep coalbed methane wells.

Accordingly, in order to accomplish the above object, the present invention provides a method for determining a productivity of a deep coalbed methane well considering impacts of fracturing fluids and produced water, comprising steps of:
step 1: obtaining basic data of a target coalbed methane well, comprising coalbed methane PVT experimental data, an original formation pressure P_{Ri}, a formation temperature T, a standard condition pressure P_{sc}, a standard condition temperature T_{sc}, a fracturing fluid amount W_{F} during a fracturing process, a Langmuir pressure P_{L}, an original free gas content G_{fi} and an original adsorbed gas content Gₐᵢ measured in laboratory, a bottomhole flow pressure P_{wf} of the coalbed methane well during production, and a daily production rate q_{sc};
step 2: based on the coalbed methane PVT experimental data obtained in the step 1, determining a relationship table between a pressure P and a coalbed methane deviation factor Z, so as to determine a coalbed methane deviation factor Zᵢ corresponding to the original formation pressure P_{Ri}; then calculating a process parameter φᵢ according to the original formation pressure P_{Ri}, the formation temperature T, the standard condition pressure P_{sc} and the standard condition temperature T_{sc} obtained in the step 1, wherein

$${φ}_{i} = \frac{{P}_{Ri} {T}_{sc}}{{P}_{sc} {Z}_{i} T} ,$$

step 3: performing stabilized bottomhole flow pressure test under constant production conditions in no less than three production stages of the coalbed methane well, and recording daily gas production rates q_{sc(1)}, q_{sc(2)}, . . . , q_{sc(n)}, bottomhole flow pressures P_{wf(1)}, P_{wf(2)}, . . . , P_{wf(n)}, cumulative gas productions GP₍₁₎, GP₍₂₎, . . . , GP₍ₙ₎, and cumulative water production WP₍₁₎, WP₍₂₎, . . . , WP₍ₙ₎ of the coalbed methane well at each stabilized flow pressure test moment;
step 4: setting an initial iterative assumption value of a gas well dynamic reserve G0, combining the cumulative gas productions GP₍₁₎, GP₍₂₎, . . . , GP₍ₙ₎ and the cumulative water production WP₍₁₎, WP₍₂₎, . . . , WP₍ₙ₎ at each stabilized flow pressure test moment in different production stages, and determining formation pressures P_{Rm(1)}, P_{Rm(2)}, . . . , P_{Rm(n)} corresponding to each stabilized flow pressure test moment based on a coalbed methane material balance equation considering the impacts of the fracturing fluids and the produced water;
step 5: according to the formation pressures P_{Rm(1)}, P_{Rm(2)}, . . . , P_{Rm(n)} corresponding to each stabilized flow pressure test moment obtained in the step 4, the bottomhole flow pressures P_{wf(1)}, P_{wf(2)}, . . . , P_{wf(n)} and the production rates q_{sc(2)}, . . . , q_{sc(n)}, determining coefficients A and B in a binomial deliverability equation for the coalbed methane well: P_{R}²−Pwf²=Aq_{sc}+Bq_{sc}², wherein P_{R} is the formation pressure, P_{wf} is the bottomhole flow pressure of the coalbed methane well, and q_{sc} is the daily production rate of the coalbed methane well;
step 6: based on the binomial deliverability equation for the coalbed methane well P_{R}²−Pwf²=Aq_{sc}+Bq_{sc}² determined in the step 5, combining the bottomhole flow pressures P_{wf(1)}, P_{wf(2)}, . . . , P_{wf(n)} and the production rates q_{sc(1)}, q_{sc(2)}, . . . , q_{sc(n)} corresponding to each stabilized flow pressure test moment obtained in the step 3, and adopting P_{R}=\sqrt{Pwf²+Aq_{sc}+Bq_{sc}²} to determine formation pressures P_{Rp(1)}, P_{Rp(2)}, . . . , P_{Rp(n)} corresponding to each stabilized flow pressure test moment, which means obtaining the formation pressures P_{Rp(1)}, P_{Rp(2)}, . . . , P_{RP(n)} based on the binomial deliverability equation; and
step 7: performing an error test between the formation pressures P_{Rm(1)}, P_{Rm(2)}, . . . , P_{Rm(n)} based on the material balance equation and the formation pressures P_{Rp(1)}, P_{Rp(2)}, . . . , P_{Rp(n)} based on the binomial deliverability equation corresponding to each stabilized flow pressure test moment; if an error between the formation pressures obtained by different methods fails to meet a preset accuracy requirement, then repeating the steps 4-6 to iterate until the preset accuracy requirement is satisfied, wherein the binomial deliverability equation obtained when the preset accuracy requirement is met is a deliverability equation for the coalbed methane well; substituting the formation pressures and the bottomhole flow pressures into the deliverability equation of the coalbed methane well for solving, thereby obtaining the productivity of the coalbed methane well under corresponding formation pressure and bottomhole flow pressure conditions.

Preferably, in the step 4, the formation pressures corresponding to each stabilized flow pressure test moment are determined as follows:
based on the original formation pressure P_{Ri} and the relationship table between the pressure P and the coalbed methane deviation factor Z, determining the coalbed methane deviation factor Zᵢ corresponding to the original formation pressure;
substituting the original formation pressure P_{Ri}, the coalbed methane deviation factor Zᵢ corresponding to the original formation pressure, the formation temperature T, the gas well dynamic reserve G0, the Langmuir pressure P_{L}, the original free gas content G_{fi}, the original adsorbed gas content Gₐᵢ, the fracturing fluid amount W_{F}, the cumulative gas production GP and the cumulative water production W_{P} at each test moment, and the process parameter φᵢ obtained in the step 2 into the coalbed methane material balance equation

$$G P = {G}_{0} * \frac{{G}_{fi}}{{G}_{fi} + {G}_{ai}} - \frac{{PZ}_{i}}{{ZP}_{i}} [ {G}_{0} * \frac{{G}_{fi}}{{G}_{fi} + {G}_{ai}} - ( {W}_{F} - {W}_{P} ) {B}_{w} {φ}_{i} ] + {G}_{0} * \frac{{G}_{ai}}{{G}_{fi} + {G}_{ai}} * ( 1 - \frac{P}{{P}_{i}} \times \frac{{P}_{i} + {P}_{L}}{P + {P}_{L}} )$$

considering the impacts of the fracturing fluids and the produced water, so as to obtain a nonlinear equation related to the formation pressure P; and solving the nonlinear equation by iterating, thereby obtaining a formation
pressure corresponding to the cumulative gas production GP at each test moment.

Preferably, in the step 4, the coalbed methane material balance equation the impacts of the fracturing fluids and the produced water is

$$G P = {G}_{0} * \frac{{G}_{fi}}{{G}_{fi} + {G}_{ai}} - \frac{{PZ}_{i}}{{ZP}_{i}} [ {G}_{0} * \frac{{G}_{fi}}{{G}_{fi} + {G}_{ai}} - ( {W}_{F} - {W}_{P} ) {B}_{w} {φ}_{i} ] + {G}_{0} * \frac{{G}_{ai}}{{G}_{fi} + {G}_{ai}} * ( 1 - \frac{P}{{P}_{i}} \times \frac{{P}_{i} + {P}_{L}}{P + {P}_{L}} ) ,$$

$$wherein {φ}_{i} = \frac{{P}_{Ri} {T}_{sc}}{{P}_{sc} {Z}_{i} T} .$$

### Beneficial Effects:

(1) The method of the present invention can fully consider the impacts of the fracturing fluid and the produced water on the coalbed methane deliverability equation. Therefore, the coalbed methane well productivity evaluation results predicted by the gas well deliverability equation determined by the method of the present invention are more in line with the actual situation on site.

(2) The method of the present invention is simple, easy to understand and perform, highly operable, effective and practical, which deserves popularization and utilization.

### BRIEF DESCRIPTION OF THE DRAWINGS

FIG. 1 is a flow chart of a method for determining a productivity of a deep coalbed methane well considering impacts of fracturing fluids and produced water according to an embodiment of the present invention; and

FIG. 2 is linear fitting of observation points.

### DETAILED DESCRIPTION OF THE PREFERRED EMBODIMENT

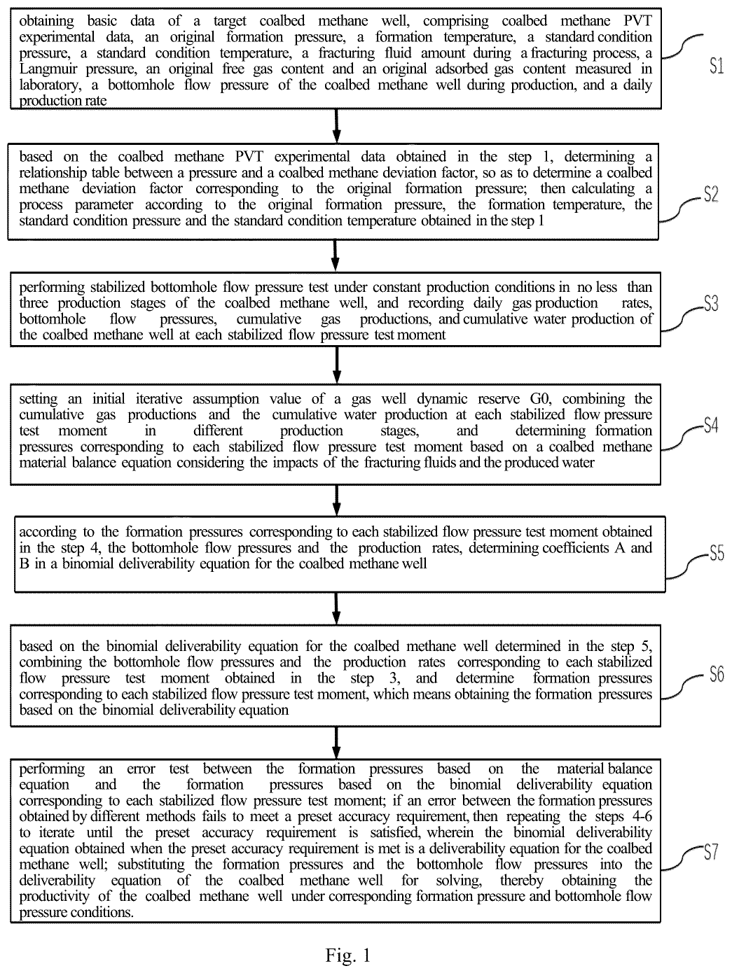

Referring to FIG. 1, the present invention provides a method for determining a productivity of a deep coalbed methane well considering impacts of fracturing fluids and produced water, comprising steps of:
step 1: obtaining basic data of a target coalbed methane well, comprising coalbed methane PVT experimental data, an original formation pressure P_{Ri}, a formation temperature T, a standard condition pressure P_{sc}, a standard condition temperature T_{sc}, a fracturing fluid amount W_{F} during a fracturing process, a Langmuir pressure P_{L}, an original free gas content G_{fi} and an original adsorbed gas content Gₐᵢ measured in laboratory, a bottomhole flow pressure P_{wf} of the coalbed methane well during production, and a daily production rate q_{sc};
step 2: based on the coalbed methane PVT experimental data obtained in the step 1, determining a relationship table between a pressure P and a coalbed methane deviation factor Z, so as to determine a coalbed methane deviation factor Zᵢ corresponding to the original formation pressure P_{Ri}; then calculating a process parameter φᵢ according to the original formation pressure P_{Ri}, the formation temperature T, the standard condition pressure P_{sc} and the standard condition temperature T_{sc} obtained in the step1, wherein

$${φ}_{i} = \frac{{P}_{Ri} {T}_{sc}}{{P}_{sc} {Z}_{i} T} ;$$

step 3: performing stabilized bottomhole flow pressure test under constant production conditions in no less than three production stages of the coalbed methane well, and recording daily gas production rates q_{sc(1)}, q_{sc(2)}, . . . , q_{sc(n)}, bottomhole flow pressures P_{wf(1)}, P_{wf(2)}, . . . , P_{wf (n)}, cumulative gas productions GP₍₁₎, GP₍₂₎, . . . , GP₍ₙ₎, and cumulative water production WP₍₁₎, WP₍₂₎, . . . , WP₍ₙ₎ of the coalbed methane well at each stabilized flow pressure test moment;
step 4: setting an initial iterative assumption value of a gas well dynamic reserve G0, based on the original formation pressure P_{Ri} and the relationship table between the pressure P and the coalbed methane deviation factor Z, determining the coalbed methane deviation factor Zᵢ corresponding to the original formation pressure;
substituting the original formation pressure P_{Ri}, the coalbed methane deviation factor Zᵢ corresponding to the original formation pressure, the formation temperature T, the gas well dynamic reserve G0, the Langmuir pressure P_{L}, the original free gas content G_{fi}, the original adsorbed gas content Gₐᵢ, the fracturing fluid amount W_{F}, the cumulative gas production GP and the cumulative water production W_{P} at each test moment, and the process parameter φᵢ obtained in the step 2 into the coalbed methane material balance equation

$$G P = {G}_{0} * \frac{{G}_{fi}}{{G}_{fi} + {G}_{ai}} - \frac{{PZ}_{i}}{{ZP}_{i}} [ {G}_{0} * \frac{{G}_{fi}}{{G}_{fi} + {G}_{ai}} - ( {W}_{F} - {W}_{P} ) {B}_{w} {φ}_{i} ] + {G}_{0} * \frac{{G}_{ai}}{{G}_{fi} + {G}_{ai}} * ( 1 - \frac{P}{{P}_{i}} \times \frac{{P}_{i} + {P}_{L}}{P + {P}_{L}} )$$

considering the impacts of the fracturing fluids and the produced water, so as to obtain a nonlinear equation related to the formation pressure P; and
solving the nonlinear equation by iterating, thereby obtaining a formation pressure corresponding to the cumulative gas production GP at each test moment
step 5: according to the formation pressures P_{Rm(1)}, P_{Rm(2)}, . . . , P_{Rm(n)} corresponding to each stabilized flow pressure test moment determined based on the material balance equation, the bottomhole flow pressures P_{wf(1)}, P_{wf(2)}, . . . , P_{wf(n)} and the production rates q_{sc(1}), q_{sc(2)}, . . . , q_{sc(n)}, introducing

$${y}_{( i )} = \frac{{P}_{R ( i )}^{2} - {P}_{wf ( i )}^{2}}{{q}_{sc ( i )}} , {x}_{( i )} = {q}_{sc ( i )} ,$$

i=1, 2, . . . , n, so as to get a series of observation points (y₍ᵢ₎, x₍ᵢ₎); processing the observation points with linear fitting to determine coefficients A and B in a binomial deliverability equation for the coalbed methane well: P_{R}²−Pwf²=Aq_{sc}+Bq_{sc}², wherein A is equal to an intercept of the fitted linear equation, and B is equal to a slope of the fitted linear equation;
step 6: based on the binomial deliverability equation for the coalbed methane well P_{R}²−Pwf²=Aq_{sc}+Bq_{sc}² determined in the step 5, combining the bottomhole flow pressures P_{wf(1)}, P_{wf(2)}, . . . , P_{wf(n)} and the production rates q_{sc(1)}, q_{sc(2)}, . . . , q_{sc(n)} corresponding to each stabilized flow pressure test moment obtained in the step 3, and adopting P_{R}=\sqrt{P_{wf}²+Aq_{sc}+Bq_{sc}²} to determine formation pressures P_{Rp(1)}, P_{Rp(2)}, . . . , P_{Rp(n)} corresponding to each stabilized flow pressure test moment, which means obtaining the formation pressures P_{Rp(1)}, P_{Rp(2)}, . . . , P_{RP(n)} based on the binomial deliverability equation; and
step 7: performing an error test between the formation pressures P_{Rm(1)}, P_{Rm(2)}, . . . , P_{Rm(n)} based on the material balance equation and the formation pressures P_{Rp(1)}, P_{Rp(2)}, . . . , P_{Rp(n)} based on the binomial deliverability equation corresponding to each stabilized flow pressure test moment; if an error between the formation pressures obtained by different methods fails to meet a preset accuracy requirement, then repeating the steps 4-6 to iterate until the preset accuracy requirement is satisfied, wherein the binomial deliverability equation obtained when the preset accuracy requirement is met is a deliverability equation for the coalbed methane well; substituting the formation pressures and the bottomhole flow pressures into the deliverability equation of the coalbed methane well for solving, thereby obtaining the productivity of the coalbed methane well under corresponding formation pressure and bottomhole flow pressure conditions.

### EXPLANATION OF SYMBOLS

P_{Ri}: original formation pressure, MPa; P_{wf}: bottomhole flow pressure, MPa; q_{sc}: gas well production rate, ten-thousand cubic meters per day; P: pressure, MPa; Z: gas deviation factor, dimensionless, decimal; Pₛ (Pₛ=P/Z): pseudo-pressure, MPa; g_{sc(i)}: daily production rate corresponding to stabilized flow pressure test point i, ten-thousand cubic meters per day; P_{wf(j)}: stabilized bottomhole flow pressure corresponding to the production rate q_{sc(i)}; GP₍ᵢ₎: cumulative gas production corresponding to stabilized flow pressure test point i, ten-thousand cubic meters; P_{Rm(i)}: formation pressure corresponding to stabilized flow pressure test point i based on material balance equation; P_{Rp(i)}: formation pressure corresponding to stabilized flow pressure test point i based on deliverability equation; i: stabilized flow pressure test point number, i=1, 2, . . . , n; P_{R}: formation pressure, MPa; G₀: dynamic reserve, ten-thousand cubic meters; T: formation temperature, K; P_{sc}: standard condition pressure, MPa; T_{sc}: standard condition temperature, K; B_{w}: volume factor of water, decimal; W_{F}: fracturing fluid amount, ten-thousand cubic meters; W_{P}: cumulative water production, ten-thousand cubic meters; G_{fi}: free gas content under original formation pressure and temperature conditions, m³/t; Gₐᵢ: adsorbed gas content under original formation pressure and temperature conditions, m³/t;φᵢ: process parameter, decimal, dimensionless,

$${φ}_{i} = \frac{{P}_{Ri} {T}_{sc}}{{P}_{sc} {Z}_{i} T} .$$

Preferably, in the step 4, the coalbed methane material balance equation considering the impacts of the fracturing fluids and the produced water is

$$G P = {G}_{0} * \frac{{G}_{fi}}{{G}_{fi} + {G}_{ai}} - \frac{{PZ}_{i}}{{ZP}_{i}} [ {G}_{0} * \frac{{G}_{fi}}{{G}_{fi} + {G}_{ai}} - ( {W}_{F} - {W}_{P} ) {B}_{w} {φ}_{i} ] + {G}_{0} * \frac{{G}_{ai}}{{G}_{fi} + {G}_{ai}} * ( 1 - \frac{P}{{P}_{i}} \times \frac{{P}_{i} + {P}_{L}}{P + {P}_{L}} ) ,$$

$$wherein {φ}_{i} = \frac{{P}_{Ri} {T}_{sc}}{{P}_{sc} {Z}_{i} T} .$$

The specific derivation of the equation is as follows.

According to the isothermal adsorption equation of the coalbed methane, the adsorbed gas content V_{gi} per unit mass of coal rock under the original formation pressure Pᵢ is:

$${V}_{gi} = \frac{{V}_{L} * {P}_{i}}{{P}_{i} + {P}_{L}} \qquad ( 1 )$$

and the adsorbed gas content per unit mass of coal rock at any formation pressure P is

$${V}_{g} = \frac{{V}_{L} * P}{P + {P}_{L}} ,$$

which means a cumulative adsorbed gas production Uₚₐ per unit mass of coal rock at any formation pressure P is:

$${U}_{pa} = {V}_{gi} - {V}_{g} = \frac{{V}_{L} * {P}_{i}}{{P}_{i} + {P}_{L}} - \frac{{V}_{L} * P}{P + {P}_{L}} \qquad ( 2 )$$

then the adsorbed gas recovery Rₐₚ corresponding to the formation pressure P is:

$${R}_{ap} = {U}_{pa} / {V}_{gi} \qquad ( 3 )$$

from the equations (1), (2) and (3):

$${R}_{ap} = \frac{\frac{{V}_{L} * {P}_{i}}{{P}_{i} + {P}_{L}} - \frac{{V}_{L} * P}{P + {P}_{L}}}{\frac{{V}_{L} * {P}_{i}}{{P}_{i} + {P}_{L}}} = 1 - \frac{P}{{P}_{i}} \frac{{P}_{i} + {P}_{L}}{P + {P}_{L}} \qquad ( 4 )$$

let the adsorbed gas reserve under the original formation pressure and temperature conditions be G₀ₐ, then it can be concluded from the adsorbed gas recovery Rₐₚ corresponding to the formation pressure P that the cumulative adsorbed gas production Gₚₐ=G₀ₐ*Rₐₚ (5)
from the equations (4) and (5):

$${G}_{pa} = {G}_{0 a} * ( 1 - \frac{P}{{P}_{i}} \frac{{P}_{i} + {P}_{L}}{P + {P}_{L}} ) \qquad ( 6 )$$

after converting the fracturing fluid amount W_{F} pressed into the formation during the fracturing of the coalbed methane well into a formation volume W_{F}B_{W}, it is used as a “water intrusion volume” Wₑ in water-driven gas reservoirs; then according to a water-driven material balance equation for gas reservoirs with normal pressure system, a free gas material balance equation considering the impacts of the fracturing fluid and the produced water production can be obtained:

$$\frac{P}{Z} = ( \frac{{G}_{0} - {G}_{P}}{{G}_{0} - ( {W}_{F} - {W}_{p} ) {B}_{w} {φ}_{i}} ) \frac{{P}_{i}}{{Z}_{i}} \qquad ( 7 )$$

$$wherein {φ}_{i} = \frac{{P}_{R i} {T}_{sc}}{{P}_{s c} {Z}_{i} T} \qquad ( 8 )$$

from the equation (7), the free gas production is:

$${G}_{Pf} = {G}_{0 f} - \frac{{PZ}_{i}}{{ZP}_{i}} [ {G}_{0 f} - ( {W}_{F} - {W}_{P} ) {B}_{w} {φ}_{i} ] \qquad ( 9 )$$

from the equations (6) and (9), a total production GP of the free gas and the adsorbed gas corresponding to the pressure P is:

$$GP = {G}_{pf} + {G}_{p a} = {G}_{0 f} - \frac{P {Z}_{i}}{{ZP}_{i}} [ {G}_{0 f} - ( {W}_{F} - {W}_{P} ) {B}_{w} {φ}_{i} ] + {G}_{0 a} * ( 1 - \frac{P}{{P}_{i}} \frac{{P}_{i} + {P}_{L}}{P + {P}_{L}} ) \qquad ( 10 )$$

let the original free gas content in the coal rock be G_{fi}, the original adsorbed gas content be Gₐᵢ and the original coalbed methane well reserve be G₀, then the free gas reserve G_{0f} under the original formation pressure and temperature conditions is:

$${G}_{0 f} = {G}_{0} * \frac{{G}_{fi}}{{G}_{fi} + {G}_{a i}} \qquad ( 11 )$$

similarly, the adsorbed gas reserve G₀ₐ under the original formation pressure and temperature conditions is:

$${G}_{0 a} = {G}_{0} * \frac{{G}_{a i}}{{G}_{fi} + {G}_{a i}} \qquad ( 12 )$$

from the equations (10), (11) and (12):

$$GP = {G}_{0} * \frac{{G}_{fi}}{{G}_{fi} + {G}_{a i}} - \frac{P {Z}_{i}}{{ZP}_{i}} [ {G}_{0} * \frac{{G}_{fi}}{{G}_{fi} + {G}_{a i}} - ( {W}_{F} - {W}_{P} ) {B}_{w} {φ}_{i} ] + {G}_{0} * \frac{{G}_{a i}}{{G}_{fi} + {G}_{a i}} * ( 1 - \frac{P}{{P}_{i}} \times \frac{{P}_{i} + {P}_{L}}{P + {P}_{L}} ) \qquad ( 13 )$$

and the equation (13) is the coalbed methane material balance equation considering the impacts of the fracturing fluids and the produced water.

Preferably, in the step 5, the coefficients A and B in the deliverability equation for the coalbed methane well are determined as follows: the binomial deliverability equation for the gas well is:

$${P}_{R}^{2} - {P}_{wf}^{2} = {Aq}_{sc} + B {q}_{s c}^{2} \qquad ( 14 )$$

dividing both ends of the equation (14) by q_{sc}:

$$\frac{{P}_{R}^{2} - {P}_{wf}^{2}}{{q}_{s c}} = A + B {q}_{s c} \qquad ( 15 )$$

since the coefficients A and B in the binomial deliverability equation are constants related to formation characteristics, they can be obtained by linear fitting based on the bottomhole flow pressure and the corresponding formation pressure under different production rate conditions.

$$making {y}_{( i )} = \frac{{P}_{R ( t )}^{2} - {P}_{wf ( i )}^{2}}{{q}_{sc ( i )}} \qquad ( 16 )$$

$${x}_{( i )} = {q}_{sc ( i )} \qquad ( 17 )$$

wherein i is a stabilized flow pressure test point number, i=1, 2, . . . , n; P_{R(i)} is a formation pressure corresponding to the stabilized flow pressure test point i; P_{wf(i)} is a stabilized bottomhole flow pressure corresponding to the production rate q_{sc(1)}; and q_{sc(i)} is a daily production rate corresponding to the stabilized flow pressure test point i. According to the gas production rates q_{sc(1)}, q_{sc(2)}, . . . , q_{sc(n)} of the coalbed methane well at each stabilized flow pressure test moment in different production stages and corresponding bottomhole flow pressures P_{wf(1)}, P_{wf(2)}, . . . , P_{wf(n)}, a series of observation points (y₍ᵢ₎, x₍ᵢ₎) can be obtained with the equation (16) and (17). After processing observation point data with linear fit, it can be seen from the equation (15) that A is equal to an intercept of a linear equation obtained from the linear fit, and B is equal to a slope of the linear equation obtained from the linear fit.

The present invention is achieved by obtaining the basic data of a coalbed methane well; based on the coalbed methane PVT experimental data, determining a relationship table between a pressure and a coalbed methane deviation factor and corresponding process parameters; recording daily gas production rates, bottomhole flow pressures, cumulative gas productions and cumulative water productions in no less than three production stages of the coalbed methane well; determining formation pressures corresponding to each stabilized flow pressure test moment based on a coalbed methane well material balance equation considering the impacts of the fracturing fluids and the produced water; according to the formation pressures corresponding to each stabilized flow pressure test moment, the bottomhole flow pressures and the daily production rates, determining coefficients in a binomial deliverability equation for the coalbed methane well, thereby obtaining the deliverability equation for the coalbed methane well; and substituting the formation pressures and the bottomhole flow pressures into the deliverability equation of the coalbed methane well for solving, thereby obtaining the productivity of the coalbed methane well. Compared with the method without considering the impacts of the fracturing fluid and the produced water, the coalbed methane well productivity evaluation results predicted by the gas well deliverability equation determined by the method of the present invention are more in line with the actual situation on site. The method of the present invention is simple, highly operable, effective and practical, which deserves popularization and utilization.

In addition, the technical solutions of the present invention will be further illustrated below with specific examples, but the protection scope of the present invention is not limited thereto.

### Validation Example 1

A coalbed methane well has a vertical depth of 2880 m in the central part of the formation, an original formation pressure of 28 MPa, and a formation temperature of 81.3° C.

According to the method for determining the productivity of the deep coalbed methane well considering the impacts of the fracturing fluids and the produced water of the embodiment:

(1) Collecting basic data of the coalbed methane well, wherein an original formation pressure P_{Ri}=28 MPa, a formation temperature T=354.45K, a standard condition pressure P_{sc}=0.101325 MPa, a standard condition temperature T_{sc}=293.15K, a fracturing fluid amount W_{F}=5.4612 during a fracturing process, a Langmuir pressure P_{L}=3.13 MPa, an original free gas content G_{fi}=7.66 m³/t and an original adsorbed gas content Gₐᵢ=18.34 m³/t measured in laboratory.

(2) Obtaining a relationship between pressure and deviation factor from PVT sampling experimental analysis data, which is shown in Table 1, wherein a coalbed methane deviation factor is Zᵢ=0.8805 corresponding to the original formation pressure P_{Ri}=28 MPa; then calculating a process parameter φᵢ according to the original formation pressure P_{Ri}=28 MPa, the formation temperature T=354.45K, the standard condition pressure P_{sc}=0.101325 MPa, and the standard condition temperature T_{sc}=293.15K obtained in the step (1), wherein

$${φ}_{i} = \frac{{P}_{Ri} {T}_{sc}}{{P}_{sc} {Z}_{i} T} = \frac{28 * 293.15}{0.101325 * 0.8805 * 354.45} = 259.5 655.$$

TABLE 1
relationship between pressure and deviation factor

| Pressure P (MPa) | Deviation factor Z (decimal) |
|---|---|
| 31 | 0.9133 |
| 28 | 0.8805 |
| 25 | 0.8716 |
| 22 | 0.8609 |
| 19 | 0.8631 |
| 16 | 0.8619 |
| 13 | 0.8715 |
| 10 | 0.8770 |
| 8.5 | 0.8843 |
| 6 | 0.9047 |
| 3 | 0.9405 |

(3) During production of the well, employing three production rates in three production stages, which were q_{sc(1)}=8.43 ten-thousand cubic meters per day, q_{sc(2)}=7.18 ten-thousand cubic meters per day, and q_{sc(3)}=5.54 ten-thousand cubic meters per day; wherein the stabilized bottomhole flow pressures under the three production rates were P_{wf(1)}=8.76 MPa, P_{wf(2)}=8.71 MPa and P_{wf(3)}=9.59 MPa, respectively; the cumulative gas productions at each stabilized flow pressure test moment were GP₍₁₎=854.6741 ten-thousand cubic meters, GP₍₂₎=1161.708 ten-thousand cubic meters and GP₍₃₎=1507.7649 ten-thousand cubic meters, respectively; the cumulative water productions at each stabilized flow pressure test moment were WP₍₁₎=2.4172 ten-thousand cubic meters, WP₍₂₎=2.6217 ten-thousand cubic meters and WP₍₃₎=2.8371 ten-thousand cubic meters, respectively.

(4) Adopting a dynamic reserve iteration model where G0₍ᵢₜₑᵣ₊₁₎=G0₍ᵢₜₑᵣ₎* (1+0.02), i.e., an assumed value of dynamic reserve at the iter+1st iteration is 1.02 times to that of the iterth iteration; setting an initial iteration assumption value G0 of the gas well dynamic reserve to 3000 ten-thousand cubic meters, wherein the iteration assumption value of the dynamic reserve is G₀=8915.1920 ten-thousand cubic meters for the 55th iteration; putting Zᵢ=0.8805 corresponding to the original formation pressure P_{Ri}=28 MPa, the formation temperature T=354.45K, the dynamic reserve G₀=8915.1920, the Langmuir pressure P_{L}=3.13 MPa, the original free gas content G_{fi}=7.66 m³/t, the original adsorbed gas content Gₐᵢ=18.34 m³/t, the fracturing fluid amount W_{F}=5.4612, the cumulative gas production GP₍₁₎=854.6741 ten-thousand cubic meters, the cumulative water production WP₍₁₎=2.4172 ten-thousand cubic meters, and the process parameter φᵢ=259.5655 obtained in the step (2) into the coalbed methane material balance equation considering the impacts of the fracturing fluids and the produced water

$$GP = {G}_{0} * \frac{{G}_{fi}}{{G}_{fi} + {G}_{a i}} - \frac{P {Z}_{i}}{Z {P}_{i}} [ {G}_{0} * \frac{{G}_{fi}}{{G}_{fi} + {G}_{a i}} - ( {W}_{F} - {W}_{P} ) {B}_{w} {φ}_{i} ] + {G}_{0} * \frac{{G}_{a i}}{{G}_{fi} + {G}_{a i}} * ( 1 - \frac{P}{{P}_{i}} \times \frac{{P}_{i} + {P}_{L}}{P + {P}_{L}} ) ,$$

so as to obtain a nonlinear equation related to the formation pressure P:

$$854.6741 = 8915.192 - 57.5009 \times \frac{P}{Z} - 6995.3 \; 54 \times \frac{P}{( P + 3.13 )} ;$$

solving by iterating to obtain a formation pressure P_{Rm(1)}=27.3099 MPa based on the material balance equation at the corresponding flow pressure test moment; similarly, using the same method to obtain the formation pressures P_{Rm(2)}=23.2614 MPa and P_{Rm(3)}=19.5425 MPa based on the material balance equation for the other two stabilized flow pressure test moments.

(5) According to the formation pressures P_{Rm(1)}=27.3099 MPa, P_{Rm(2)}=23.2614 MPa and P_{Rm(3)}=19.5425 MPa corresponding to each stabilized flow pressure test moment determined based on the material balance equation, the bottomhole flow pressure P_{wf(1)}=8.76 MPa, P_{wf(2)}=8.71 MPa and P_{wf(3)}=9.59 MPa, and the production rates q_{sc(1)=}8.43 ten-thousand cubic meters per day, q_{sc(2)}=7.18 ten-thousand cubic meters per day and q_{sc(3)}=5.54 ten-thousand cubic per day, making

$${y}_{( i )} = \frac{{P}_{R ( t )}^{2} - {P}_{wf ( i )}^{2}}{{q}_{sc ( i )}} , {x}_{( i )} = {q}_{s c ( i )} ,$$

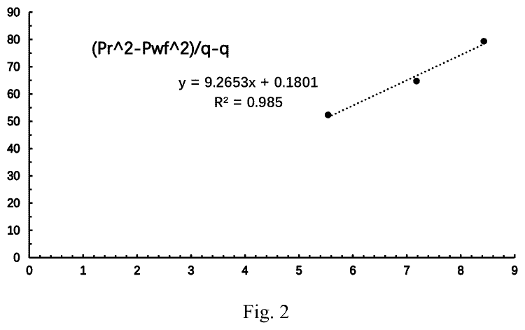

i=1, 2, . . . , n, and obtaining a series of observation points (y₍ᵢ₎, x₍ᵢ₎) (see table 2); processing observation point data with linear fit (see FIG. 2) for determining coefficients in a binomial deliverability equation for the coalbed methane well: P_{R}²−Pwf²=Aq_{sc}+Bq_{sc}², wherein A=0.1801 and B=9.2653.

TABLE 2
data table for observation point construction

| | | | qsc(i) | | |
|---|---|---|---|---|---|
| observation | | | (ten-thousand | | |
| point No. | Pr(i) | Pwf(i) | cubic meters | x(i) = | y(i) = [Pr²(i) − |
| (i) | (Mpa) | (MPa) | per day) | q_{sc}(i) | pwf²(i)]/q_{sc}(i) |
| 1 | 27.3099 | 8.76 | 8.43 | 8.43 | 79.3705 |
| 2 | 23.2614 | 8.71 | 7.18 | 7.18 | 64.7951 |
| 3 | 19.5425 | 9.59 | 5.54 | 5.54 | 52.3360 |

(6) based on the deliverability equation for the coalbed methane well P_{R}²−Pwf²=0.1801q_{sc}+9.2653q_{sc}² determined in the step 5, combining the bottomhole flow pressures P_{wf(1)}=8.76 MPa, P_{wf(2)}=8.71 MPa and P_{wf(3)}=9.59 MPa, and the production rates q_{sc(1)}=8.43 ten-thousand cubic meters per day, q_{sc(2)}=7.18 ten-thousand cubic meters per day and q_{sc(3)}=5.54 ten-thousand cubic meters per day corresponding to each stabilized flow pressure test moment, and adopting P_{R}=\sqrt{Pwf²+0.1801q_{sc}+9.2653q_{sc}²} to determine formation pressures corresponding to each stabilized flow pressure test moment to be P_{Rp(1)}=27.1421 MPa, P_{Rp(2)}=23.5543 MPa, P_{Rp(3)}=19.4251 MPa.

(7) Performing an error test between the formation pressures P_{Rm(1)}=27.3099 MPa, P_{Rm(2)}=23.2614 MPa and P_{Rm(3)}=19.5425 MPa based on the material balance equation obtained in the step (4) and the formation pressures P_{Rp(1)=}27.1421 MPa, P_{Rp(2)}=23.5543 MPa, P_{Rp(3)}=19.4251 MPa based on the deliverability equation obtained in the step (6) corresponding to each stabilized flow pressure test moment; calculating relative errors with Err(i)=abs(P_{Rm(i)}−P_{Rp(i1)})/P_{Rm(i)}, wherein the relative errors between the formation pressures obtained by different methods were Err(1)=0.0061, Err(2)=0.0126 and Err(3)=0.0060, which were apparently less than 5%, satisfying the accuracy requirements for mine application; in the iteration meeting the accuracy requirements, the coefficients of gas well deliverability equation obtained were A=0.1801 and B=9.2653, and thus the binomial deliverability equation for the gas well in the embodiment was P_{R}²−Pwf²=0.1801q_{sc}+9.2653q_{sc}²; when the formation pressure P_{R}=23.2614 MPa and P_{wf}=8.71 MPa, the deliverability equation of the gas well was 9.2653q_{sc}²+0.1801q_{sc}−23.2614²+8.71²=0; by solving the deliverability equation we can get q_{sc}=7.0798 ten-thousand cubic meters per day; thus, when the formation pressure was 23.2614 MPa and the bottomhole flow pressure was 8.71 MPa, the productivity of the gas well was 7.0798 ten-thousand cubic meters per day.

If the impacts of the fracturing fluids and the produced water are not considered, the deliverability equation will be determined as P_{R}²−Pwf²=1.0427q_{sc}+4.5509q_{sc}². When the formation pressure P_{R}=23.2614 MPa and P_{wf}=8.71² MPa, the deliverability equation will be 4.5509q_{sc}²+1.0427q−23.2614²+8.71²=0. By solving the deliverability equation we can get q_{sc}=19.0531 ten-thousand cubic meters per day. Since the well was fractured and put into production, when the bottomhole pressure is around 8.7 MPa, the daily production rate of the well has never exceeded 11 ten-thousand cubic meters per day, but around 6.8-8.5 ten-thousand cubic meters per day. Therefore, there is a large discrepancy between the productivity of the well without considering the impacts of the fracturing fluids and the produced water and the actual production situation, whereas the productivity of the well after considering the impacts of the fracturing fluids and the produced water is more in line with the actual production situation.

The above is preferred embodiment of the present invention, but the embodiments of the present invention are not limited by the above description. Any modifications without deviating from the present invention shall be equivalent replacement methods, and shall be included in the protection scope of the present invention.

What is claimed is:

1. A method for determining a productivity of a deep coalbed methane well considering impacts of fracturing fluids and produced water, comprising steps of:
step 1: obtaining basic data of a target coalbed methane well, comprising coalbed methane PVT experimental data, an original formation pressure P_{Ri}, a formation temperature T, a standard condition pressure P_{sc}, a standard condition temperature T_{sc}, a fracturing fluid amount W_{F} during a fracturing process, a Langmuir pressure P_{L}, an original free gas content G_{fi} and an original adsorbed gas content Gₐᵢ measured in laboratory, a bottomhole flow pressure P_{wf} of the coalbed methane well during production, and a daily production rate q_{sc};
step 2: based on the coalbed methane PVT experimental data obtained in the step 1, determining a relationship table between a pressure P and a coalbed methane deviation factor Z, so as to determine a coalbed methane deviation factor Zᵢ corresponding to the original formation pressure P_{Ri}; then calculating a process parameter φⱼ according to the original formation pressure P_{Ri}, the formation temperature T, the standard condition pressure P_{sc} and the standard condition temperature T_{sc} obtained in the step 1, wherein
$${φ}_{i} = \frac{{P}_{Ri} {T}_{sc}}{{P}_{sc} {Z}_{i} T} ;$$
step 3: performing stabilized bottomhole flow pressure test under constant production conditions in no less than three production stages of the coalbed methane well, and recording daily gas production rates q_{sc(1)}, q_{sc(2)}, . . . , q_{sc(n)}, bottomhole flow pressures P_{wf(1)}, P_{wf(2)}, . . . , P_{wf(n)}, cumulative gas productions GP₍₁₎, GP₍₂₎, . . . , GP₍ₙ₎, and cumulative water production WP₍₁₎, WP₍₂₎, . . . , WP₍ₙ₎ of the coalbed methane well at each stabilized flow pressure test moment;
step 4: setting an initial iterative assumption value of a gas well dynamic reserve G0, combining the cumulative gas productions GP₍₁₎, GP₍₂₎, . . . , GP₍ₙ₎ and the cumulative water production WP₍₁₎, WP₍₂₎, . . . , WP₍ₙ₎ at each stabilized flow pressure test moment in different production stages, and determining formation pressures P_{Rm(1)}, P_{Rm(2)}, . . . , P_{Rm(n)} corresponding to each stabilized flow pressure test moment based on a coalbed methane material balance equation considering the impacts of the fracturing fluids and the produced water;
step 5: according to the formation pressures P_{Rm(1)}, P_{Rm(2)}, . . . , P_{Rm(n)} corresponding to each stabilized flow pressure test moment obtained in the step 4, the bottomhole flow pressures P_{wf(1)}, P_{wf(2)}, . . . , P_{wf(n)} and the production rates q_{sc(1)}, q_{sc(2)}, . . . q_{sc(n)}, determining coefficients A and B in a binomial deliverability equation for the coalbed methane well: P_{R}²−Pwf²=Aq_{sc}+Bq_{sc}², wherein P_{R} is the formation pressure, P_{wf} is the bottomhole flow pressure of the coalbed methane well, and q_{sc} is the daily production rate of the coalbed methane well;
step 6: based on the binomial deliverability equation for the coalbed methane well P_{R}²−Pwf²=Aq_{sc}+Bq_{sc}² determined in the step 5, combining the bottomhole flow pressures P_{wf(1)}, P_{wf(2)}, . . . , P_{wf(n)} and the production rates q_{sc(1)}, q_{sc(2)}, . . . , q_{sc(n)} corresponding to each stabilized flow pressure test moment obtained in the step 3, and adopting P_{R}=\sqrt{Pwf²+Aq_{sc}+Bq_{sc}²} to determine formation pressures P_{Rp(1)}, P_{Rp(2)}, . . . , P_{Rp(n)} corresponding to each stabilized flow pressure test moment, which means obtaining the formation pressures P_{Rp(1)}, P_{Rp(2)}, . . . , P_{RP(n)} based on the binomial deliverability equation; and
step 7: performing an error test between the formation pressures P_{Rm(1)}, P_{Rm(2)}, . . . , P_{Rm(n)} based on the material balance equation and the formation pressures P_{Rp(1)}, P_{Rp(2)}, . . . , P_{Rp(n)} based on the binomial deliverability equation corresponding to each stabilized flow pressure test moment; if an error between the formation pressures obtained by different methods fails to meet a preset accuracy requirement, then repeating the steps 4-6 to iterate until the preset accuracy requirement is satisfied, wherein the binomial deliverability equation obtained when the preset accuracy requirement is met is a deliverability equation for the coalbed methane well; substituting the formation pressures and the bottomhole flow pressures into the deliverability equation of the coalbed methane well for solving, thereby obtaining the productivity of the coalbed methane well under corresponding formation pressure and bottomhole flow pressure conditions.

2. The method, as recited in claim 1, wherein in the step 4, the formation pressures corresponding to each stabilized flow pressure test moment are determined as follows:
based on the original formation pressure P_{Ri} and the relationship table between the pressure P and the coalbed methane deviation factor Z, determining the coalbed methane deviation factor Zᵢ corresponding to the original formation pressure;
substituting the original formation pressure P_{Ri}, the coalbed methane deviation factor Zᵢ corresponding to the original formation pressure, the formation temperature T, the gas well dynamic reserve G0, the Langmuir pressure P_{L}, the original free gas content G_{fi}, the original adsorbed gas content Gₐᵢ, the fracturing fluid amount W_{F}, the cumulative gas production GP and the cumulative water production W_{P} at each test moment, and the process parameter φᵢ obtained in the step 2 into the coalbed methane material balance equation considering the impacts of the fracturing fluids and the produced water, so as to obtain a nonlinear equation related to the formation pressure P; and
solving the nonlinear equation by iterating, thereby obtaining a formation pressure corresponding to the cumulative gas production GP at each test moment.

3. The method, as recited in claim 1, wherein in the step 4, the coalbed methane material balance equation considering the impacts of the fracturing fluids and the produced water is
$$G P = {G}_{0} * \frac{{G}_{f i}}{{G}_{f i} + {G}_{a i}} - \frac{P {Z}_{i}}{Z {P}_{i}} [ {G}_{0} * \frac{{G}_{f i}}{{G}_{f i} + {G}_{a i}} - ( {W}_{F} - {W}_{P} ) {B}_{w} {φ}_{i} ] + {G}_{0} * \frac{{G}_{a i}}{{G}_{f i} + {G}_{a i}} * ( 1 - \frac{P}{{P}_{i}} \times \frac{{P}_{i} + {P}_{L}}{P + {P}_{L}} ) , wherein {φ}_{i} = \frac{{P}_{R i} {T}_{s c}}{{P}_{sc} {Z}_{i} T} .$$
